(19) United States
(12) Patent Application Publication
(10) Pub. No.: US 2009/0314284 A1
(43) Pub. Date: Dec. 24, 2009

(54) SOLAR ABSORPTIVE COATING SYSTEM

(76) Inventor: Forrest S. Schultz, Menomonie, WI (US)

Correspondence Address: BOYLE FREDRICKSON S.C., 840 North Plankinton Avenue, MILWAUKEE, WI, 53203, US

(21) Appl. No.: 12/490,778

(22) Filed: Jun. 24, 2009

Related U.S. Application Data
(60) Provisional application No. 61/075,235, filed on Jun. 24, 2008.

(51) Int. Cl. F24J 2/46; B23P 25/00

(52) U.S. Cl. 126/710; 29/458

(57) ABSTRACT

A paintable, low VOC coating improving the solar absorption of materials consists of an aqueous suspension of nanoparticle aluminum oxide, carbon nanotubes, and carbon black.

### CROSS REFERENCE TO RELATED APPLICATIONS

This Application claims the benefit of U.S. Provisional Application 61/075,235 filed Jun. 24, 2008 and hereby incorporated by reference.

### BACKGROUND OF THE INVENTION

Heat and hot water costs represent the largest portion of a typical monthly utility bill for both homes and businesses. Solar hot water heating is a promising technology for harnessing the energy of the sun to replace up to 75% of the fossil fuels consumed in these applications.

A typical solar heating system requires a solar collector having high absorption in the spectral range of the sun and low emissivity (re-radiation of energy from the collector). Good thermal conductivity in the collector is required to transfer the absorbed heat, typically to circulating water, for storage and later use in air and water heating.

The combination of qualities needed for a solar collector are often obtained through the use of a metallic collector plate (aluminum or copper) coated with a petroleum-based absorptive paint. A widely used selective solar coating for this purpose is manufactured by Solec-Solar Energy Corporation of Ewing, N.J., under the Trade Name: Solkote Hi/Sorb-II. This material has the following characteristics:
0.88-0.94 (Solar Absorption);
0.28-0.49 (Surface Emission); and
2.36 (Ratio of Averaged Absorption/Emission).

In comparison, common carbon black paint offers excellent absorption characteristics, 0.96, but demonstrates poor emission characteristics, 0.88, leading to an absorption/emission ratio of 1.09.

Solkote Hi/Sorb-II, for example, uses a silicon polymer as a binder in a xylene solvent. This formulation requires the release of some volatile organic compounds (VOCs) into the environment and requires that workers applying this material to collector panels have suitable protection.

### SUMMARY OF THE INVENTION

The present invention provides a water-based solar absorptive coating consisting of a combination of nano particulate aluminum oxide mixed with carbon nanotubes and common black pigments such as carbon black. The nano particulate aluminum oxide may be prepared through an alcohol/water sol-gel process.

While the inventor does not wish to be bound by a particular theory, it is believed that the carbon nanotubes improve the absorption of sunlight in the UV, visible and infrared, regions based on their physical structure and provide improved heat conduction through the coating to the underlying metallic substrate. It is probable that the carbon nanotubes contribute significantly to the strength of the matrix of aluminum oxide.

The nano particulate aluminum oxide provides a binder and separator for the carbon nanotubes and carbon black. The optical properties of aluminum oxide are appropriate for allowing transmission of solar radiation therethrough and because the resulting coating has been demonstrated to be about 50% porous, the coating should act as a thermal insulator to reduce the re-emission of heat energy from the collector substrate.

### BRIEF DESCRIPTION OF THE DRAWINGS

FIG. 1 is a simplified schematic of a solar collector suitable for use with the coating material of the present invention; and

FIG. 2 is an exaggerated cross-sectional view through the solar collector of FIG. 1 showing the coating material of the present invention.

### DETAILED DESCRIPTION OF THE INVENTION

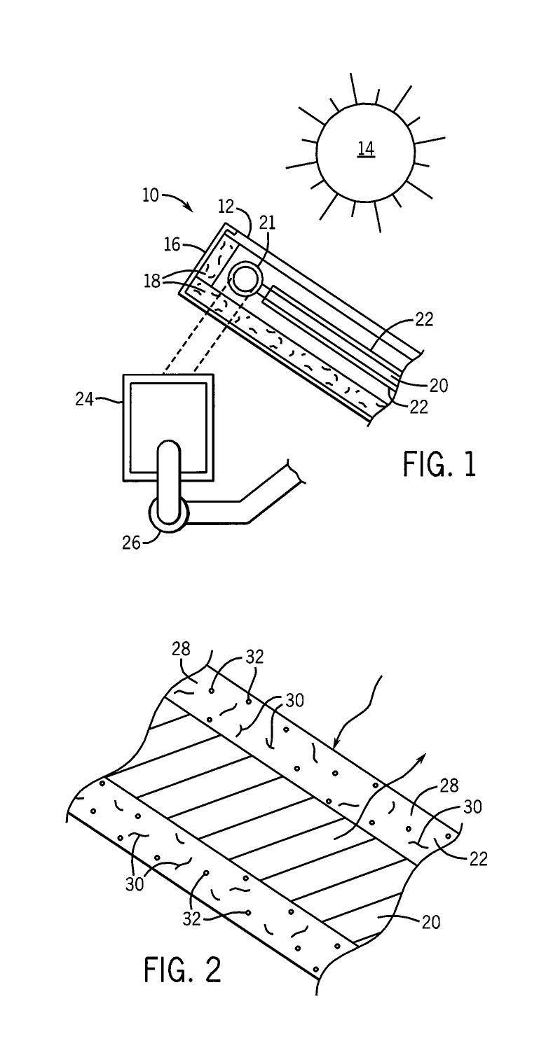

Referring now to FIG. 1, a solar collector 10 may provide, for example, a front glazing 12 such as glass, angled to receive light from the sun 14 at an angle as close to perpendicular as possible. The glazing 12 forms the front face of a collector box 16 that may be internally insulated with compressed glass wool 18 or the like.

Positioned within the collector box 16 is a metallic collector panel 20 attached to one or more pipes 21 through which water may be circulated. Heat from the sun 14 is received by the collector panel 20 whose surface is coated with absorptive coating 22 to increase its absorption and decrease its emission of energy.

Heat from the metallic collector panel 20 is conducted to the pipe 21 and water contained in pipe 21. The heated water may flow to a storage tank 24 as circulated by a pump 26 or the like. Appropriate heat exchangers (not shown) may be used to extract heat from the storage tank 24 for heating water or air.

Referring now to FIG. 2, the collector panel 20 may be coated on both sides (as shown) or on one side only with an absorptive coating 22 which comprises a matrix of nano particulate aluminum oxide 28 holding suspended therein dispersed carbon nanotubes 30 and carbon black particles 32. The coating process may use any of a variety of well-known techniques including electrophoretic deposition, spraying, dipping, painting, and printing. The side away from the sun may be bare metal, or may be treated with a low emissivity material or a modification of the present material.

### Example I

Nano particulate aluminum oxide was prepared using the alcohol process described, for example, in “The Effects of Surface Adsorption and Confinement on the Photochemical Selectivity of Previtamin D3 Adsorbed Within Porous Sol-Gel Derived Alumina”, Schultz, F. S., Anderson, M. A., Journal of the American Chemical Society, 1999, 121, 4933-4940, hereby incorporated by reference. The resulting nano particulate aluminum oxide had the following characteristics: 6-10 nm in diameter γ-Al2O3 particles with an overall porosity of ˜50%. Generally, the term nanoscale will mean particles less than 1000 nm in diameter and the aluminum oxide particles are preferably less than 100 nm in diameter.

Carbon nanotubes and carbon black obtained from Cheap Tubes, Inc. of Brattleboro, Vt. and comprising approximately 90% percent single-walled carbon nanotubes and these characteristics, an outer diameter of 1-2 nm and a length of 5-30 um (and preferably less than 100 μm) were then suspended in aqueous solution using a surfactant, e.g. polyvinyl alcohol, under sonication. Preliminary experiments suggest that similar adsorptive gains are observed with multi-walled carbon nanotubes. The suspended carbon nanotubes and carbon black were mixed with stirring with the aluminum oxide sol, after which water was allowed to evaporate to produce a thickened solution suitable for coating. The proportions of these elements are listed below in Table A.

TABLE A

| Ingredient | Percentage by weight |
|---|---|
| Water | 95 |
| Aluminum oxide nanoparticles | 4.7 |
| Carbon nanotubes | 0.25 |
| Carbon black | 0.01 |

A coating of approximately 40μ was applied to an aluminum plate by brush and allowed to air dry. The coating performance was tested by measuring the temperature gain at the backside of an aluminum substrate on which the coating was deposited. When using a standard 1000 W halogen lamp, a 10% increase in temperature was observed with the described coating when compared with Solkote Hi/Sorb-II. In an alternative embodiment, each coated sheet may be fired at high temperatures to cure the ceramic matrix.

### Example II

Sol-gel derived nano-particulate alumina oxide was obtained through hydrolysis of aluminum tri-sec-butoxide. The resulting sol was diluted to 50% and CNTs and polyvinylpyrrolidone (PVP) was added with sonication to create a solution/suspension of CNTs and alumina particles in water.

Deposition of the coating was accomplished through electrophorectic deposition. The aluminum panel to be coated was the cathode (negative) and a copper plate is used for the anode (positive) with the plating voltage kept constant at 5 volts while the current and plating time controlled by the spacing between the anode and cathode. Ethanol was added to the solutions to reduce hydrogen gas formation at the cathode.

Using the electrophoretic process only the side of the aluminum substrate facing the anode was coated with the alumina/CNT coating. This raises the possibility of coding only one side of the formal collector or changing the formulation of the coating material (for example to remove the carbon nanotube) on the side of the panel not exposed to the sun.

Coatings were then dried in air with a heat-gun. Some coatings were fired at 300° C. for two hours.

Deposition thickness and CNT distribution was observed with a Tescan Vega II SEM. Absorption experiments were conducted in an insulated box with a polycarbonate window. The light source was a 250 W halogen bulb with 9000 lux reaching the samples. UV-Vis/NIR measurements were made Perkin Elmer Lamda 900 Spectrometer (performed at UW-Platteville).

### Results

Six types of CNT's were examined to evaluate the characteristics of solution preparation and solar absorption. Formulation parameters for quantities of alumina, water, PVP, ethanol, and CNT are given in Table B. In these tables, Sol-Tec refers to one of several current industry standard black coating used in solar thermal applications.

TABLE B

| Solution | PVP | Water | Alumina | CNT Type | Sonication Time | Ethanol |
|---|---|---|---|---|---|---|
| A | 0.397 g | 25 ml | 25 ml | 0.05 g >50 nm Multiwall | 12 min | — |
| B | 0.300 g | 25 ml | 25 ml | 0.05 g >50 nm Multiwall | 12 min | — |
| C | 0.200 g | 25 ml | 25 ml | 0.05 g >50 nm Multiwall | 12 min - | — |
| D | 0.180 g | 25 ml | 25 ml | 0.05 g 20-40 nm Multiwall | 12 min | — |
| E | 0.230 g | 25 ml | 25 ml | 0.05 g 1-2 nm Singlewall | 20 Min | — |
| F | 0.158 g | 25 ml | 25 ml | 0.05 g 20-40 nm OH-Multi | 12 min | — |
| G | 0.057 g | 25 ml | 25 ml | 0.05 g 20-40 nm Multiwall | 12 min | — |
| H | 0.700 g | 125 ml | 125 ml | 0.15 g 50> nm Multiwall | 12 min - | — |
| I | 0.200 g | 0 ml | 50 ml | 0.04 g 20-40 nm Multiwall | 12 Min | — |
| J | 0.190 g | 25 ml | 25 ml | — | — | — |
| K | 0.200 g | 21 ml | 25 ml | 0.05 g 20-30 nm Multiwall | 12 Min | 4 ml |

The various solutions labeled A-K were then coated on aluminum substrates with test parameters shown in Table C.

TABLE C

| Trial | Solution | Time (min) | Voltage |
|---|---|---|---|
| 1 | A | 3 | 3.2 |
| 2 | A | 4 | 3.35 |
| 3 | A | 3 | 5 |
| 4 | A | 2 | 5 |
| 5 | A | 2 | 5 |
| 6 | A | 2.5 | 5 |
| 7 | A | 3 | 5 |
| 8 | A | 2.5 | 5 |
| 9 | A | 2.5 | 5 |
| 10 | A | 2.5 | 5 |
| 11 | A | 2.5 | 5 |
| 12 | A | 2.5 | 5 |
| 13 | A | 2.5 | 5 |
| 14 | B | 2.5 | 5 |
| 15 | B | 2.5 | 5 |
| 16 | B | 3 | 5 |
| 17 | B | 2 | 5 |
| 18 | B | 2 | 5 |
| 19 | B | 1.5 | 5 |
| 20 | B | 1 | 5 |
| 21 | B | 1.25 | 5 |
| 22 | B | 1.5 | 5 |
| 23 | B | 1.25 | 5 |
| 24 | C | 2 | 5 |
| 25 | C | 1.5 | 5 |
| 26 | C | 2 | 5 |
| 27 | C | 3 | 5 |
| 28 | C | 1.75 | 5 |
| 29 | C | 2 | 5 |
| 30 | C | 2 | 5 |
| 31 | C | 1.83 | 5 |
| 32 | C | 2 | 5 |
| 33 | C | 2 | 5 |
| 34 | C | 2 | 5 |
| 35 | C | 1.75 | 5 |
| 36 | A | 2 | 5 |
| 37 | A | 2.5 | 5 |
| 38 | A | 2.5 | 5 |
| 39 | A | 2.25 | 5 |
| 40 | A | 2.5 | 5 |
| 41 | A | 2 | 5 |
| 42 | A | 3 | 5.25 |
| 43 | A | 2 | 4.85 |
| 44 | A | 2 | 4.6 |
| 45 | A | 1.75 | 4.6 |
| 46 | A | 2.5 | 4 |
| 47 | D | 2 | 5 |
| 48 | D | 1 | 5 |
| 49 | D | 2 | 5 |
| 50 | D | 2.5 | 5 |
| 51 | D | 1.75 | 5 |
| 52 | D | 1.33 | 5 |
| 53 | D | 0.75 | 5 |
| 54 | D | 0.58 | 5 |
| 55 | D | 0.42 | 5 |
| 56 | D | 0.33 | 5 |
| 57 | D | 0.5 | 5 |
| 58 | D | 0.5 | 5 |
| 59 | D | 0.5 | 5 |
| 60 | A | 0.5 | 5 |
| 61 | A | 0.5 | 5 |
| 62 | E | 2 | 5 |
| 63 | F | 0.5 | 5 |
| 64 | F | 0.75 | 5 |
| 65 | F | 1.25 | 5 |
| 66 | F | 1 | 5 |
| 67 | F | 1.08 | 5 |
| 68 | F | 0.83 | 5 |
| 69 | F | 55 sec | 5 |
| 70 | C | 0.58 | 5 |
| 71 | C | 0.42 | 5 |
| 72 | C | 0.42 | 5 |
| 73 | C | 0.33 | 5 |
| 74 | C | 0.37 | 5 |
| 75 | D | 0.42 | 5 |
| 76 | D | 0.5 | 5 |
| 77 | D | 0.5 | 5 |
| 78 | D | 0.5 | 5 |
| 79 | D | 0.53 | 5 |
| 80 | D | 0.58 | 5 |
| 81 | G | 0.42 | 5 |
| 82 | G | 0.5 | 5 |
| 83 | G | 0.58 | 5 |
| 84 | G | 0.53 | 5 |
| 85 | G | 0.58 | 5 |
| 86 | E | 0.5 | 5 |
| 87 | E | 0.5 | 5 |
| 88 | E | 0.5 | 5 |
| 89 | J | 0.5 | 5 |
| 90 | D | 0.5 | 5 |
| 91 | D&J | 0.5 | 5 |
| 92 | C | 0.5 | 5 |

A SEM was used to measure and evaluate the coating thickness as deposition time varied. As can be seen in Table D, the thickness generally increase with deposition time. There are some inconsistencies that appear to exist because of inconsistencies in the separation distance between the anode and cathode during the deposition process. The samples were coated from the same solution and started at 15 seconds exposure time and increased in 5 second intervals to 40 seconds. All coatings used solution K. One particularly interesting result was the coating characteristics of Sample 2 in Table D. An SEM image of Sample 2 shows rectangular shapes thought to be single crystals of alumina.

TABLE D

| Sample | Time | Thickness (um) |
|---|---|---|
| 1 | 15 sec | 2.079 |
| 2 | 20 sec | 0.975 |
| 3 | 25 sec | 1.743 |
| 4 | 30 sec | 2.598 |
| 5 | 35 sec | 7.642 |
| 6 | 40 sec | 3.555 |

In Tables B, solutions C, D, and F applied per trials 59, 65, 73, 74, and 80 of Table C were the better performing coatings as indicated in Table E below

TABLE E

| | | Maximum | | Maximum | | Maximum | | Maximum |
|---|---|---|---|---|---|---|---|---|
| | | Temperature | | Temperature | | Temperature | | Temperature |
| Trial | Coating | (° C.) | Coating | (° C.) | Coating | (° C.) | Coating | (° C.) |
| 1 | 56 | 44.54 | 53 | 45.62 | Sol-Tec | 45.59 | 79 | 45.26 |
| 2 | 63 | 46.55 | 72 | 45.95 | 57 | 45.35 | Sol-Tec | 44.59 |
| 3 | 18 | 43.89 | Sol-Tec | 44.86 | 64 | 44.19 | 54 | 43.63 |
| 4 | 85 | 44.35 | 82 | 43.28 | Sol-Tec | 45.67 | 87 | 44.51 |
| 5 | Sol-Tec | 42.60 | 72 | 42.44 | 73 | 44.03 | 63 | 43.76 |
| 6 | 84 | 52.91 | 71 | 53.16 | 80 | 54.36 | Sol-Tec | 52.26 |
| 7 | Sol-Tec | 52.54 | 57 | 52.20 | 79 | 52.78 | 70 | 52.17 |
| 8 | 74 | 53.35 | 59 | 53.53 | Sol-Tec | 51.26 | 65 | 52.97 |
| 9 | Sol-Tec | 53.72 | 65 | 55.23 | 74 | 52.05 | 59 | 54.78 |
| 10 | 10 | 48.87 | 83 | 43.31 | Sol-Tec | 48.73 | 78 | 48.81 |
| 11 | 64 | 49.48 | 81 | 49.89 | Sol-Tec | 50.07 | 54 | 50.69 |
| 12 | 61 | 49.71 | 56 | 50.84 | Sol-Tec | 48.67 | 70 | 49.57 |
| 13 | 73 | 50.13 | 57 | 50.99 | Sol-Tec | 49.83 | 79 | 50.63 |
| 14 | 77 | 50.21 | 85 | 51.02 | Sol-Tec | 50.04 | 80 | 50.90 |
| 15 | Sol-Tec | 48.90 | 84 | 49.25 | 71 | 49.71 | 65 | 50.51 |
| 16 | Sol-Tec | 49.05 | 59 | 49.51 | 74 | 48.84 | 47 | 50.45 |
| 17 | Sol-Tec | 51.50 | MiroTherm | 52.26 | Aluminum | 43.36 | 85 | 51.59 |

These coatings and their percentage temperature increase over Sol-Tec are: Coating 59 (7.8%), Coating 73 (6.9%), Coating 74 (7.5%) and Coating 80 (8.3%) as show in Table E. The MiroTherm sample is a newly developed coating that has come to market most recently. This is a rather expensive material and does perform slightly better in our testing.

One of the important considerations for the overall coating performance is the durability of the coating toward physical and environmental effects. Almost all of the coatings adhered to the aluminum substrate very well, but some did perform better to simple scratch tests and washing with water and other solvents. It was also observed in SEM images that flaking and irregularities were observed to a different extent with the various coatings. The coatings made with solution K, containing ethanol, were the best adhered coatings. These coatings were durable to scratching to a getter extent than the Sol-Tec coating. It was also observed that baking the coating at 300° C. for two hours produced a coating that was not affected by water or other solvents.

Table F shows the overall solar absorptance of various samples. Most of the samples displayed an absorptance value of about 0.7. This corresponds to a 70% absorption of the available solar light. Sample 88 contained single-walled CNTs and displayed much lower absorptance. Sample 89 contained no CNTs and exhibited an absorptance that was a little less than uncoated aluminum. The samples labeled UWP1-5 represented samples of increasing thickness from 1 to 8 um. Although the differences were small, it does appear that thicker samples do display a high absorptance value.

TABLE F

| Sample | Solar Absorptance |
|---|---|
| Aluminum | 0.173 |
| Mirotherm | 0.714 |
| Sample 55 | 0.683 |
| Sample 59 | 0.696 |
| Sample 68 | 0.637 |
| Sample 72 | 0.681 |
| Sample 75 | 0.690 |
| Sample 82 | 0.705 |
| Sample 88 | 0.515 |
| Sample 89 | 0.110 |
| Sample 90 | 0.699 |
| Sample 91 | 0.693 |
| Sample 92 | 0.694 |
| Sol-Tec | 0.695 |
| UWP1 | 0.662 |
| UWP2 | 0.660 |
| UWP3 | 0.684 |
| UWP4 | 0.694 |
| UWP5 | 0.692 |

These experimental results suggest that alumina/CNT composite material is an effective black solar coating for solar thermal applications. Performance data indicates that multi-walled CNTs with diameters in the range of 20-40 nm perform better than other types of CNTs. PVP is used to produce a solution of CNTs with sol-gel derived alumina nanoparticles in water. PVP does not seem to add to the overall performance of the resulting coatings. Infrared data does suggest that the PVP is deposited in the coating. The electrophoretic deposition process worked very well with this coating material. The process is scalable as aluminum substrates as large as eight feet

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

I claim:

1. A solar absorption coating comprising: an aqueous suspension of a transparent ceramic matrix material and carbon nanotubes.

2. The solar absorption coating of claim 1 wherein the transparent ceramic material is aluminum oxide.

3. The solar absorption coating of claim 2 wherein aluminum oxide is nano scale particles.

4. The solar absorption coating of claim 3 wherein the aluminum oxide particles are less than 100 nm in diameter.

5. The solar absorption coating of claim 2 wherein the aluminum oxide is a sol.

6. The solar absorption coating of claim 2 wherein a ratio of aluminum oxide nanoparticles to carbon nanotubes by weight is greater than 10.

7. The solar absorption coating of claim 1 wherein the carbon nanotubes have a length of less than 100 μm.

8. The solar absorption coating of claim 1 further including carbon black.

9. A solar collector plate comprising a conductive metal substrate having a coating of transparent ceramic matrix material and carbon nanotubes.

10. The solar collector plate of claim 9 further including a set of liquid conduits in thermal communication with the plate for conducting heat from the plate into a liquid contained in the conduits upon circulating of the liquid through the liquid conduits.

11. The solar collector plate of claim 10 further including an insulated container holding the plate and having a front glazing allowing sunlight to enter the container to strike the coating on the plate.

12. The solar collector plate of claim 9 wherein the transparent ceramic material is nanoscale aluminum oxide.

13. The solar collector plate of claim 9 further including carbon black.

14. The solar collector plate of claim 9 wherein a ratio of aluminum oxide nanoparticles to carbon nanotubes by weight is greater than 10.

15. A method of manufacturing a solar collector comprising:
(a) preparing an aqueous suspension of a transparent ceramic matrix material and carbon nanotubes;
(b) applying the transparent ceramic matrix material and carbon nanotubes over a surface of a thermally conductive plate; and
(c) drying the solution to substantially remove free water therefrom to form a solar absorption coating on the thermally conductive plate.

16. The method of manufacture of claim 15 further comprising firing the plate at elevated temperature to cure the ceramic.

17. The method of manufacture of claim 15 wherein in the applying of the transparent ceramic matrix material and carbon nanotubes employs electrophoresis.

18. The method of manufacture of claim 15 wherein the transparent ceramic material is nanoscale aluminum oxide.

19. The method of manufacture of claim 15 further including carbon black.
